(19) United States
(12) Patent Application Publication
(10) Pub. No.: US 2003/0126441 A1
(43) Pub. Date: Jul. 3, 2003

(54) Method and system for single authentication for a plurality of services

(76) Inventors: Thorsten O. Laux, Santa Clara, CA (US); Mikhail Voitenko, Hamburg (DE); Bernd Eilers, Hamburg (DE)

Correspondence Address: SONNENSCHEIN NATH & ROSENTHAL, P.O. BOX 061080, WACKER DRIVE STATION, CHICAGO, IL, 60606-1080, US

(21) Appl. No.: 10/298,960

(22) Filed: Nov. 19, 2002

(30) Foreign Application Priority Data
Nov. 21, 2001 (EP) 01 127 722.5

(51) Int. Cl. H04L 9/00

(52) U.S. Cl. 713/168; 713/185

(57) ABSTRACT

Methods and systems consistent with the present invention provide an efficient manner of authentication for a plurality of services in a computing environment. When a first service of a plurality of related services is accessed, the user requesting access is provided with a security token that can be used by the user to efficiently access any one of the plurality of services on subsequent accesses. On subsequent accesses after the first access, the user may provide the requested service with the security token which ensures that the user is authorized to use that service. In this manner, the user only needs to provide its authentication information, e.g., log in, once to access any number of related services. This eliminates the need for multiple log-ins for multiple uses of a plurality of services thereby increasing speed, efficiency and reducing time and effort.

### CROSS REFERENCE TO RELATED APPLICATION

This application is related to, and claims priority to, European Patent Application No. 01 127 722.5, filed on Nov. 21, 2001, commonly owned, and entitled “Single Authentication for a Plurality of Services,” and which is hereby incorporated by reference herein in its entirety.

### BACKGROUND

1. Field of the Invention

The present invention generally relates to a method and system for authentication in a data processing system. In particular, the present invention generally relates to handling a plurality of services with a single authentication.

2. Background Information

Data processing devices are used for a wide range of versatile applications, providing services to potentially large numbers of different users. The applications may range from editing of text documents or spreadsheet applications to complex software systems, for example, for computer aided design and manufacturing, purchasing, computer aided banking applications, entertainment applications, and numerous other application areas. Increasingly complex software applications are employed in the field of personal services, for example, for personal data organization and mobile communication applications such as mobile telephones or communications services and other services provided over computer networks, such as the Internet.

Where communication takes place over computer networks, the increasing number of elements involved in computer-supported service environments increases the need for appropriate authentication of each user of such a system to avoid abuse of user-specific, personal data or any other data related to the authorized operation of the computing environments.

However, while the number of computer-supported applications and services is significantly increasing over time, typical systems for appropriate authentication of a user of such a system still rely on an individual authentication of the user for each single service. When accessing multiple services in a computing environment, the user usually has to separately authenticate himself for each one of these services to obtain the related functionality.

Typically, for each single service, an associated log-in mechanism requires authentication of the user, e.g., through submission of a user name and a user password, whereas for security reasons it is often not acceptable to keep passwords in related memories and pass them between different service applications.

While an authentication functionality may be easily implemented in a “closed” environment, such as an operating system on a personal computer or a main frame where applications and interactions can easily exchange data, in a distributed environment using a plurality of data processing devices in a computer network, the realization of an authentication functionality may become complex and cumbersome. If a user interacts with different services on different data processing devices, currently an individual authentication is required upon initialization of each single service on the respective data processing devices. This applies even if the user previously submitted this information to a plurality of other data processing devices.

Moreover, authentication procedures are further complicated because authentication mechanisms of individual services running on data processing devices may differ, which in turn makes it difficult to provide an appropriate presentation of applications for a user. Still further, repeated requests for authentication during a session or interaction between the user and the computing environment remain another disadvantage of typical solutions because each request interrupts a provision of services to the user, thereby reducing efficiency of user interaction.

FIG. 1 depicts a block diagram representation of a related art system for providing services and authentication of those services. The figure shows a client 102 having a browser 104 and servers 106, 108 and 110 for providing services 112, 114, and 116. As shown in the figure, a user (not shown) makes a service request to access a service 112, 114, or 116 provided on one of the servers 106, 108, and 110. When the browser 104 receives the request, it contacts the corresponding server that has the requested service. When the server is contacted, it authenticates the source of the request, i.e., the client 102, by requesting identification information certifying the client's identity, such as a user name and password.

At this point, a user may be prompted for a user name and password by the browser 104 on the client 102. The user enters the user name and password, the browser 104 forwards the authentication information to the server, and the server determines the authenticity of the authentication information and determines whether the client gets access to the related service. For example, if the user may log-in to server 106 to access service 112.

However, if the user then wishes to access a service 114 provided by a different server 108, the user must log-in to that server for that service by being prompted to provide authentication information and providing the authentication information. Similarly, the user must perform a separate log-in to access the separate server 110 to access service 116. These multiple log-ins may be inefficient for a user attempting to use multiple services. Services located on different servers may be related services, and this manner of logging into each individual service when attempting to use multiple services can be inefficient while wasting resources and time. Repeated user authorization operations may be cumbersome and may also deter a user from requesting services. It is therefore desirable to overcome these and related problems.

### SUMMARY OF THE INVENTION

Methods and systems consistent with the present invention provide an efficient manner of authentication for a plurality of services in a computing environment. When a first service of a plurality of related services is accessed, the user requesting access is provided with a security token that can be used by the user to efficiently access any one of the plurality of services on subsequent accesses. On subsequent accesses after the first access, the user may provide the requested service with the security token which ensures that the user is authorized to use that service. In this manner, the user only needs to provide its authentication information, e.g., log in, once to access any number of related services. This eliminates the need for multiple log-ins for multiple uses of a plurality of services thereby increasing speed, efficiency and reducing time and effort.

In accordance with methods and systems consistent with the present invention, a method in a data processing system for providing authentication for a plurality of services is provided. The method comprises the steps of receiving authentication information from a client to access one of the plurality of services, and determining validity of the authentication information. The method further comprises, when it is determined that the authentication information is valid, sending to the client a security token that enables the client to access all of the plurality of services.

In accordance with methods and systems consistent with the present invention, a data processing system for providing authentication for a plurality of services is provided. The data processing system comprises a memory having program instructions, and a processor configured to execute the program instructions to receive authentication information from a client to access one of the plurality of services, determine validity of the authentication information, and when it is determined that the authentication information is valid, send to the client a security token that enables the client to access all of the plurality of services.

In accordance with methods and systems consistent with the present invention, a method in a data processing system for providing authentication for a plurality of services is provided. The method comprises the steps of sending authentication information to access one of the services in the plurality of services, and receiving a security token enabling access to the plurality of services.

In accordance with methods and systems consistent with the present invention, a data processing system for providing authentication for a plurality of services is provided. The data processing system comprises a memory having program instructions, and a processor configured to execute the program instructions to send authentication information to access one of the services in the plurality of services, and receive a security token enabling access to the plurality of services.

In accordance with the methods and system consistent with the present invention, a computer-readable medium containing instructions for controlling a data processing system to perform a method for providing authentication for a plurality of services is provided. The method comprises receiving authentication information from a client to access one of the plurality of services, and determining validity of the authentication information. The method further comprises, when it is determined that the authentication information is valid, sending to the client a security token that enables the client to access all of the plurality of services.

### BRIEF DESCRIPTION OF THE DRAWINGS

The accompanying drawings, which are incorporated in and constitute a part of this specification, illustrate embodiments in accordance with the present invention and, together with the description, serve to explain the advantages and principles consistent with the present invention.

FIG. 1 depicts a block diagram of a related art system for providing services and authentication of those services by logging a user into each server having a service.

FIG. 2 shows a block diagram of a system for authentication for a plurality of services in accordance with methods and systems consistent with the present invention.

FIGS. 3a-b are flowcharts illustrating steps of a method for authentication for a plurality of services in accordance with methods and systems consistent with the present invention.

FIG. 4 is a flowchart illustrating steps in a method for terminating a session of related services and a security token associated with a user, and disconnection of session-related connections in accordance with methods and systems consistent with the present invention.

FIG. 5 shows a block diagram of another exemplary system for authentication for a plurality of services wherein the service returns the service response data directly back to the client in accordance with methods and systems consistent with the present invention.

FIG. 6 shows a block diagram of another exemplary system for authentication for a plurality of services wherein the service resides on a different server than the session manager in accordance with methods and systems consistent with the present invention.

FIG. 7 is a flowchart showing steps of an exemplary method for authentication of a plurality of services wherein the service resides on a different server than the session manager in accordance with methods and systems consistent with the present invention.

FIG. 8 shows a block diagram of another exemplary system for authentication for a plurality of services wherein the service resides on a different server than the session manager in accordance with methods and systems consistent with the present invention.

FIG. 9 illustrates a flowchart of the steps for determining whether new application software needs to be installed and associated with an existing security token in accordance with methods and systems consistent with the present invention.

FIGS. 10a-10c illustrate different ways of determining whether a new application module should be installed in accordance with methods and systems consistent with the present invention.

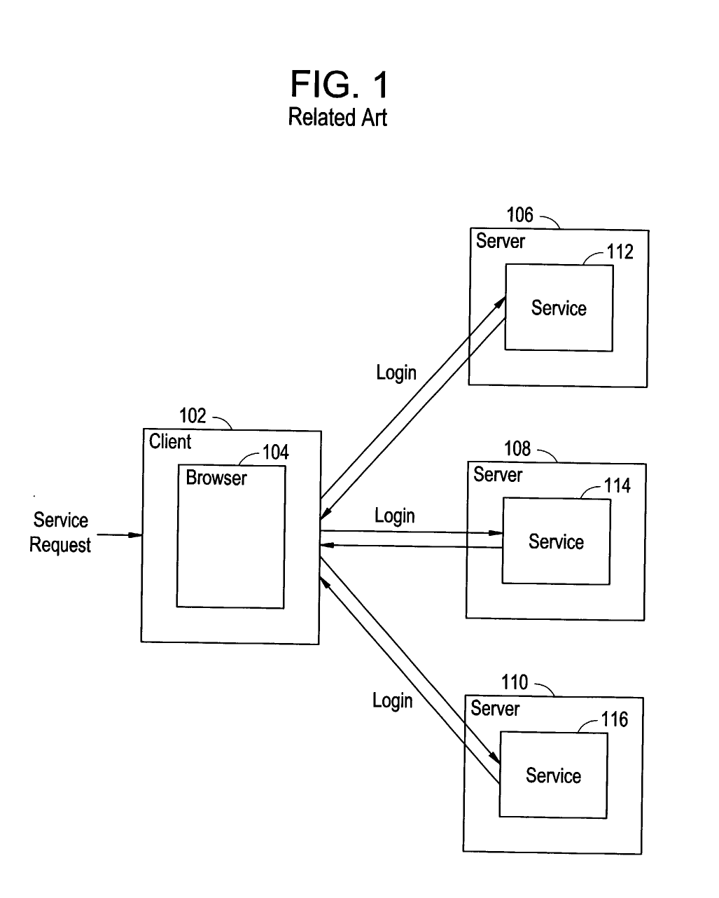

### DETAILED DESCRIPTION

Methods and systems consistent with the present invention provide an efficient manner of authentication for a plurality of services in a computing environment. When a first service of a plurality of related services is accessed, the user requesting access is provided with a security token that can be used by the user to efficiently access any one of the plurality of services on subsequent accesses. On subsequent accesses after the first access, the user may provide the requested service with the security token which ensures that the user is authorized to use that service. In this manner, the user only needs to provide its authentication information, e.g., log in, once to access any number of related services. This eliminates the need for multiple log-ins for multiple uses of a plurality of services thereby increasing speed, efficiency and reducing time and effort.

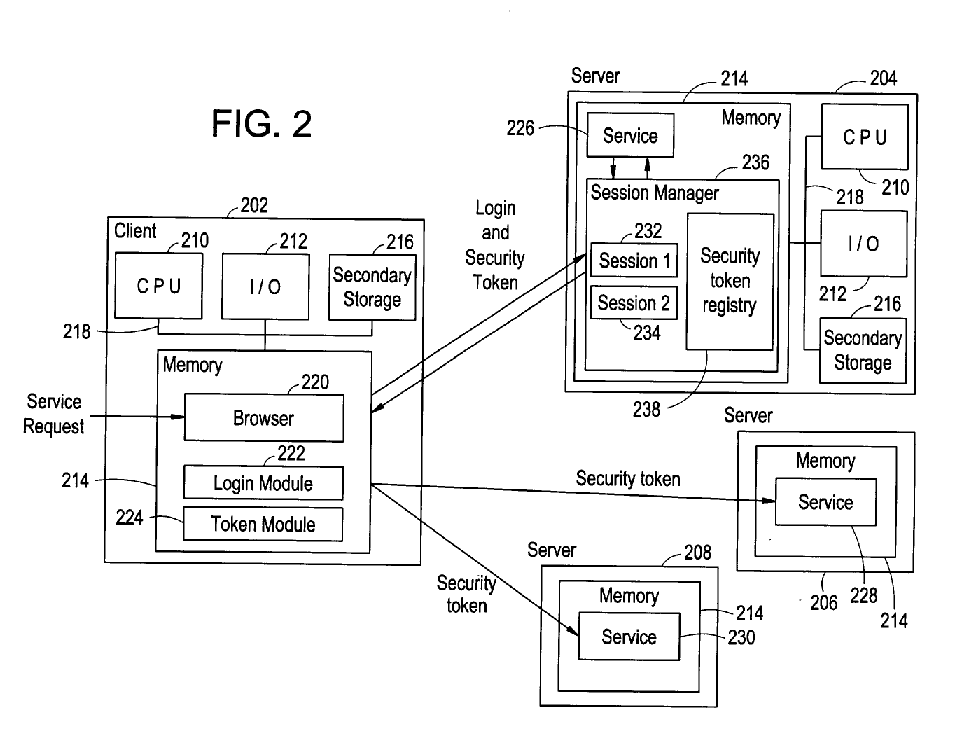

FIG. 2 shows a block diagram of a system for authentication for a plurality of services in accordance with method and systems consistent with the present invention. As an overview of one embodiment in accordance with the present invention, a user who desires to access one or more of the plurality of related services 226, 228, and 230 via a client 202 sends a request to a server 204. The server 204 prompts the user to log-in and provide authentication information such as a user name and a password. After verifying that the authentication information is valid, the server 204 sends a unique security token back to the client 202. The client 202 may then send this security token to any server 204, 206 or 208 having a desired service 226, 228 or 230 that is associated with this security token without logging into that server. In this way, the user does not need to do multiple log-ins to verify his identity and authorization to use multiple services. In one embodiment in accordance with the present invention, if the requested service 226 is on the same server 204 that originally authenticated the user, that server automatically forwards the request to the service.

As a consequence, once a user has achieved a first successful authentication towards the related service, at least one service or server 204 associated with the related services has verified the authenticity of the authentication information. As a result, repeated authentication to additional related services becomes unnecessary when information about a first valid authentication within the related services is apparent to all others. Upon initialization of a first service, the user may then use the security token for access to the service simply by adding the security token to the service request before submission of the service request.

This process will be detailed below, and it will be shown that there are many different ways of implementing methods and systems in accordance with the present invention. In addition, information on a data processing system suitable for use with a methods and systems in accordance with the present invention will be described.

FIG. 2 also depicts a block diagram of an exemplary data processing system suitable for practicing methods and implementing systems consistent with the present invention. FIG. 2 depicts a client computer 202 and server computers 204, 206 and 208, and any of the computers may represent any kind of data processing device, such as a general purpose data processing device, a personal computer, a plurality of interconnected data processing devices, a mobile computing device, a personal data organizer, a mobile communication device including mobile telephones or other similar devices. The client 202 and servers 204, 206 and 208 may represent computers in a distributed computing environment, such as Sun One Webtop developed by Sun Microsystems, Inc.

A client 202 includes a central processing unit 210 (“CPU”), and input-output (“I/O”) unit 212, a memory 214 such as a random access memory (“RAM”) or other dynamic storage device for storing information and instructions to be executed by the CPU. The client 202 also includes a secondary storage device 216, such as a magnetic disk or optical disk that may communicate with each other via a bus 218 or other communication mechanism.

Although aspects of methods and systems consistent with the present invention are described as being stored in memory, one having skill in the art will appreciate that all or part of methods and systems consistent with the present invention may be stored on or read from other computer-readable media, such as secondary storage devices 216, like hard disks, floppy disks, and CD-ROM; a carrier wave received from a network such as the Internet; or other forms of ROM or RAM either currently known or later developed. Further, although specific components of the data processing system are described, one skilled in the art will appreciate that a data processing system suitable for use with methods, systems, and articles of manufacture consistent with the present invention may contain additional or different components.

The client 202 may further include input devices such as a keyboard, and mouse or speech processor (not shown) and a display device (not shown) such as a cathode ray tube (“CRT”), for displaying information to a user. The client 202 may include a human user or may include a user agent. The term “user” as used herein refers to a human user, software, hardware or any other entity using the system.

As shown, the memory 214 in the client 202 includes a browser 220, a log-in module 222, and a token module 224. A browser application 220 is typically any program or group of application programs allowing convenient browsing through information or data available in distributed environments, such as the Internet or any other network including local area networks. A browser application 220 generally allows viewing, downloading of data and transmission of data between data processing devices. The browser 220 may also be other kinds of applications.

The token module 224 may support functionality and storage with respect to the security token, and the log-in module 222 supports functionality related to the authentication of an user. For logging in, the log-in module 222 may assist in setting up an authentication window, such as a browser window, for input of authentication data at the display. Furthermore, while an example of the authentication information has been described as a user password and a user name, any other appropriate approach to authentication may be used. For example, methods and systems consistent with the present invention may employ the evaluation of biometric data such as finger prints, the scanning of an eye, and also physical means of authentication such as keys, identification cards, etc.

Although only one browser 220 and client 202, and three servers 204, 206 and 208 and services 226, 228 and 230 are shown on FIG. 2, any number of browsers, clients, servers, services, etc. may be used. Additionally, although some components are shown in the memory 214, these components may reside elsewhere, such as in the secondary storage 216, or on another computer, such as another server. Furthermore, these components may be hardware or software whereas embodiments in accordance with the present invention are not limited to any specific combination of hardware and/or software.

FIG. 2 also depicts a server 204 that includes a CPU 210, an I/O unit 212, a memory 214 having a session manager 236 and a service 226, and a secondary storage device 216 that communicate with each other via a bus 218. As with other components, the session manager 236 may also reside elsewhere, such as secondary storage 216 or on another server. The server 204 may also have many of the components mentioned in conjunction with the client 202.

Services 226, 228, and 230 may be any application, e.g., a text processing application, a graphics application, a spreadsheet application, an application of a mobile computing device including a mobile telephone, a banking application, and entertainment application, or any other application. The services 226, 228, and 230 may be applications implementing StarOffice or related products such as Sun One Webtop. The services 226, 228, and 230 may also be implemented as hardware and may provide any functionality.

Typically, sessions 232 and 234 may be tracked and managed by the session manager 236. A session 232 occurs when a user accesses one or more services in a group of related services 226, 228, and 230. Such a period of access may typically last until a time period has ended, the user specifically requests to end the session 232, or the server 204 ends the session. A session 232 may be related to a user, a group of services and a security token. One example of a session 232 may be the relation of a plurality of services 226, 228, and 230 to a browser 220 and one or more plug-ins that request different services like browsing the Internet, audio and video services, etc.

The session manager 236 handles the administration of sessions 232 and 234, session context information associated with a session, and the triggering of services on at least one data processing device, such as a server, also referred to a service host. The session manager 236 manages administration of user data, authentication information verification, identification of the requested services 226, 228, and 230, etc.

The session manager 236 may reside in a distributed computing environment where administration of session context information is assigned to a first data processing device, such as a server 204, which may be referred to as an entry or access server. In an embodiment in which the session manager 236 is the access point, one advantage is that a user has only a single entry point into the related services 226, 228, and 230 and that all data exchanges are handled via the single entry point.

The provision of services may be assigned to at least one data processing device. In one embodiment, the service-providing server may be the same server as the server 204 which includes the session manager 236.

Whereas the session manager 236 controls access to the related services 226, 228, and 230, it can support flexibility in service processing. For example, different users may be handled with different priorities. In this example, the session manager 236 may set up a priority queue putting in the users with higher priority before ones with lower priority.

Session management typically relates to the administration of a plurality of session related data for different end users. Each session 232 has associated session management context data which may include the related user name and user profile and/or other authentication data. The user profile may be static or dynamic data classifying the user with respect to authorization for access to services, preferred data exchange formats, user priority, etc. The session management context may also comprise the security token which has been returned to the user upon successful authentication, and a list of active services and related connection points to the services. In addition, according to another embodiment, the session management context may also comprise a list of services supported through installation of related application modules or application software at the client side.

Each session management context may be maintained in a memory 214 but could also be maintained on a secondary storage 216 or permanent memory, allowing access of the session management context after a complete shut down of a related data processing system. Upon resuming operations, the session management context may be reloaded for subsequent analysis of information with respect to different services provided to different users.

The session manager 236 may also include a security token registry 238 that contains a list of all security tokens and related information. Security tokens may be used to uniquely identify authenticity. In one embodiment, security tokens are used to uniquely identify a user and one or more services 226 associated with that user, and in another embodiment, the security token is used to uniquely identify a session 232.

The security token may be any kind of information allowing an identification for the purpose of obtaining a service 226 or establishing a session 232. It may be generated by a component such as the session manager 236. The security token may be constituted by any sequence of digits, characters or any other identifying piece of information allowing an unambiguous identification for authentication purposes. Additionally, a security token may also be provided via a chip card or equivalently smart card handed out to a user. The user may plug in the smart card or chip card carrying the security token to any appropriate device supporting the services requested by the user.

Another alternative is the use of a “cookie,” which is set when a user connects to a server 204. A cookie may be unique for the connection of a user to a server 204, and it may be managed at the client side to specify a browser session. Other alternative embodiments include the use of a plurality of security tokens for a single session, or a combination of cookies and at least one security token for the handling of a single service session wherein the cookie will be used for access to the entry server 204 and session manager 236, as the communication with this server is achieved via the browser 220 and the security token may be used for access to the service host. Although different examples for the provision of security tokens are provided, other components, methods and systems may be used to implement the security token.

The handling of security tokens during service sessions in various embodiments allows for the implementation of valuable mechanisms for user support. One example would be for handling security-sensitive services, such as remote banking, remote access to personal data, etc. In this example, one way of handling security token management would be to block the allowance of the security token at all the related services after a service-specific period of time. For example, a security token provided for remote banking may be blocked after a relatively short period of time so that no person has access to such a banking account. A further possibility would be to change a security token during an ongoing session 232 through repeated provision of this security token to the end user without repeated authentication. In this case, the user is repeatedly provided with security tokens at certain points in time without repeated authentication to increase the security level for the ongoing service session 232.

An additional example for the handling of security tokens could be that the security tokens are provided in a way dependent on the area of application, e.g., each security token is only provided for a specific country, region in a country, etc. Yet another example for security management would be that for charged services, a security token is only provided when the requesting user has previously deposited a sufficient amount of money with the service provider. In this case, a continuous monitoring of the deposited service compensation amount may be achieved, and a security token provided to the user may be blocked once the amount of money is no longer enough to pay for the requested services. All the examples given for security token management are illustrations of possibilities and are not limiting whereas any other methods or systems may be used.

Referring again to FIG. 2, servers 206 and 208 may have similar components shown on server 204. The client 202 and servers 204, 206 and 208 may communicate directly or over networks, and may communicate via wired and/or wireless connections or any other method of communication. Communication may be done through any communication protocol, including known and yet to be developed communication protocols. The network may comprise many more clients 202 and servers 204, 206, and 208 than those shown on the figure, and the client and server may also have additional or different components than those shown.

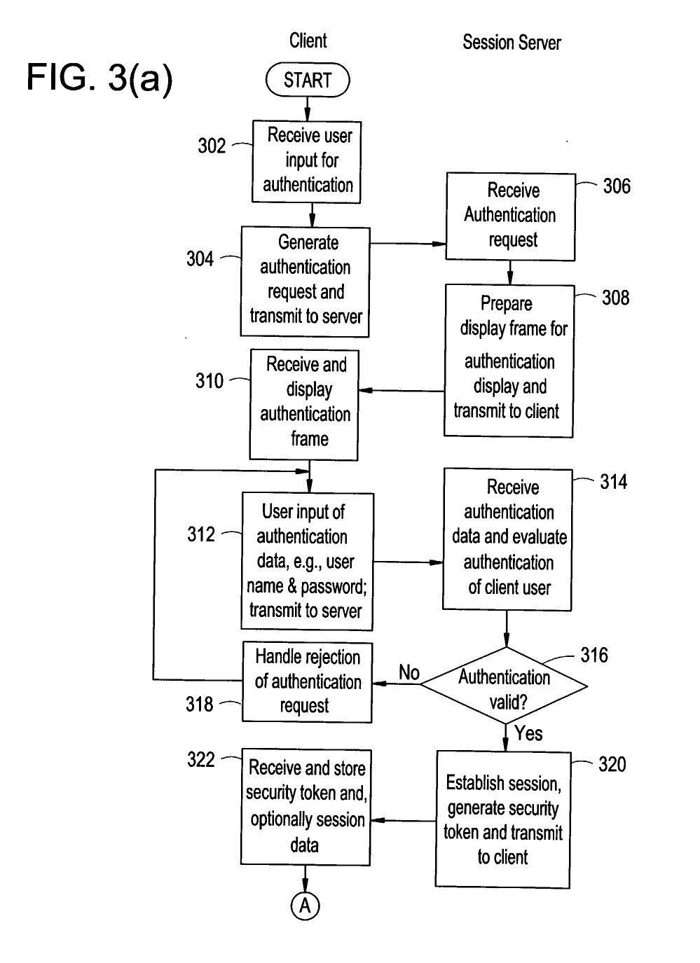

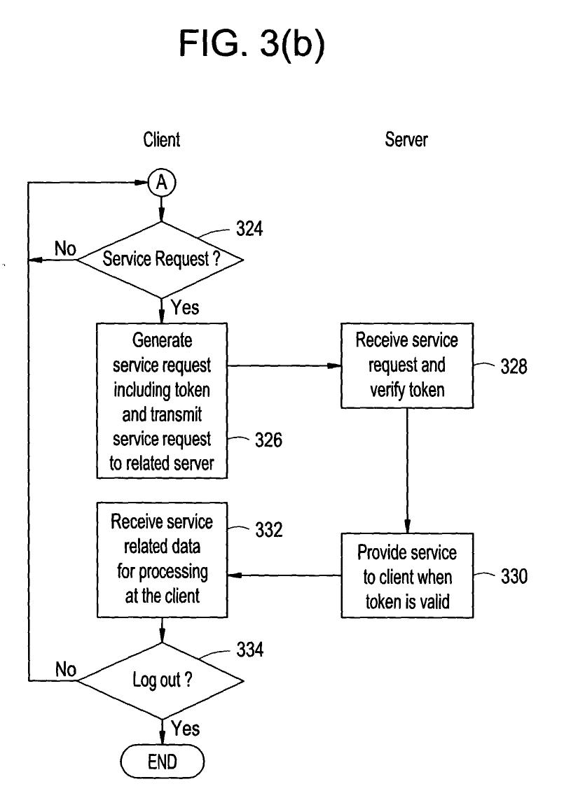

FIGS. 3a and 3b are flowcharts illustrating steps of a method for authentication for a plurality of services 226, 228, and 230 in accordance with method and systems consistent with the present invention, and will be discussed in conjunction with FIG. 2. First, the client browser 220 receives a user input for authentication (step 302) and generates an authentication request for transmission to the entry server 204 having the session manager 236 (step 304). The server 204 receives the authentication request (step 306) and prepares a display frame for authentication display and transmission to the client 202 (step 308).

Then the client 202 receives and displays the authentication frame for subsequent user input of authentication information, e.g., user name and password (step 310). In another embodiment, the display frame is generated locally at the client 202 for display for reduction of amount of data to be exchanged between the client and the server 204.

The user inputs the authentication information for transmission to the server 204 (step 312). In response, the server 204 receives the authentication information and verifies this information for the client 202 (step 314). The session manager 236 on the server 204 evaluates whether the authentication has been successful (step 316). If not, the server forwards rejection information to the client 202 which then handles the rejection of the authentication request (step 318). At this point, one option for handling the rejection is to prompt the user again for input of the authentication information so that the user has the option to correct it (step 312). Another option is closing the connection between the client 202 and the server 204.

If authentication has been successful, the session manager 236 on the server 204 will then establish a session 232 and generate a security token for transmission to the client 202 (step 320). Generating the security token may employ any technique to obtain a piece of information allowing an unambiguous identification for authentication purposes, and may be performed by the session manager 236 or other components. The session manager 236 transmits the security token to the client 202, and in response to transmission of the security token, the client 202 receives the security token for maintenance and subsequent use (step 322). Some options for maintenance of the received security token may be storage in the memory 214 of the client 202, a data file or a storage media external to the client.

Optionally, along with the security token, other session-related data, such as service connection points, may be transmitted from the session manager 236 and maintained by the client 202 for speed of subsequent service access. Service connection points supply the client 202 with a reference to location of a service so that the client may access the service directly using the security token thereby increasing speed. For example, on FIG. 2, the server 202 may have supplied the client 202 with service connection points referencing services 228 and 230. Service connection points may take many different forms such as an IP address, port number or other number assigned to a service running on a server.

A user requesting a service 228 may then not only submit a service request but also have direct access to the related service through the received related service connection points. That corresponding service host 206 may verify the security token and then directly return the service response data to the client 202.

When using service connection points, optionally, there may be the possibility to select from a plurality of service hosts 204, 206 and 208 for provision of services 226, 228, and 230 in response to a submitted service request. A best available service host may be selected on the basis of the provided available connection points. A possible benefit is the implementation of a load balancing between a plurality of services to different users. Another example is the assignment of at least one user to a specific service, or a group of users to a group of services.

Referring now to FIG. 3b, the client 202 maintains a continuous evaluation whether a user has submitted a service request to the client (step 324). The service request may include an instruction to perform any processing operation, such as processing, executing, transferring, managing or editing information, etc. The service request could also be issued by any application located within the client 202 or externally, in which case the service request could be received over a communication link. In one embodiment, the service request may be a click on a reference in a HTML page, and the browser 220 receives an HTML request. If no request is received, the evaluation is repeated (step 324). Otherwise, if a request has been submitted, the client 202 generates a service request including the security token for transmission to the server 204 having the desired service 226 (step 326).

In one embodiment in accordance with the present invention, as shown in this example of FIG. 2, the desired service 226 resides on the same server 204 as the session manager 236 that receives the service request. The session manager 236 receives the service request and checks the security token (step 328). In this embodiment, the session manager 236 directly forwards the service request from the client 202 to the service 226. As illustrated by the arrows on the FIG. 2, the client 202 could have accessed the other services 228 and 230 on the servers 206 and 208.

As shown in FIG. 2, the service 226 receives a service request, processes the request and generates service response data (step 330). In this embodiment, the data is returned to the session manager 236 which returns the data to the client 202. The client 202 then receives the service response data for local processing on the client (step 332).

As will be described below, there are numerous variations of the forwarding of a service request and/or security token, and the location of services, e.g., the server may forward a received request and received security token to the service host server, the server may evaluate the security token but forward the request to the service host server, the client 202 may directly contact the service host server, etc. There are also numerous ways that the service response data may be returned to the client 202, e.g., via the session manager 236 or directly back to the client. Subsequent to the reception of requested data, the user or client 202 may access additional related services (step 324) such as services 228 and 230 on servers 206 and 208 using the same security token, or the client may log out and end the session 232 (step 334).

In another embodiment, the user may access a service directly from the client 202 to the service host when the service is provided on a server 206 or 208 separate from the session manager 236. As illustrated in FIG. 2, the client 202 may directly forward a service request from the client to the service 228 on a service host server 206. According to this scenario, the service 228 receives the service request with the security token for evaluation of the allowance of the submitted request on the basis of the submitted security token. If the result of the evaluation is positive, the service 228 processes of the service request and returns the service response data to the client 202. Otherwise, the service 228 may reject the submitted service request.

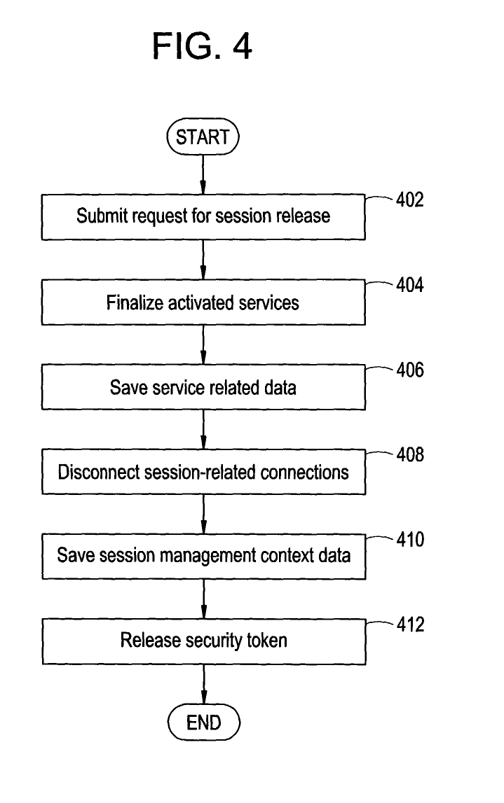

FIG. 4 is a flowchart illustrating steps in a method for terminating a session of related services and a security token associated with a user, and disconnection of session-related connections in accordance with methods and systems consistent with the present invention. Initially, the client 202 indicates to the session manager 236 that it wants to release a session 232 through submission of a related request or logging out (step 402). Logging out may be related to a session 232 or to a shut down of the client 202 or browser 220 itself. The session manager 236 may optionally finalize activated services (step 404) and optionally save service-related data (step 406) to avoid waste of processing time already used. In this situation, the session manager 236 then releases and disconnects session-related connections between the session manager 236, related services 226, 228, and 230 and the client 202 (step 408). Optionally, session management context data may be saved, e.g., debiting, auditing, and/or service recovery (step 410). Finally, the security token may be released for subsequent use in a further service session 234 (step 412). A session 232 may also expire after a specified amount of time. In one embodiment, the temporary characteristic of the security token increases security within the related services since it may only be used during the time period when the session 232 is maintained at the session manager 236.

The session manager 236 may choose freely between a direct and immediate shutdown of a service session 232 upon request or a consistent, secure and documented session shutdown. Which way is appropriate may depend on the kind of services. For example, for banking services, documented and saved session information may be appropriate while less security-specific services such as video games may allow for an immediate shutdown upon user request.

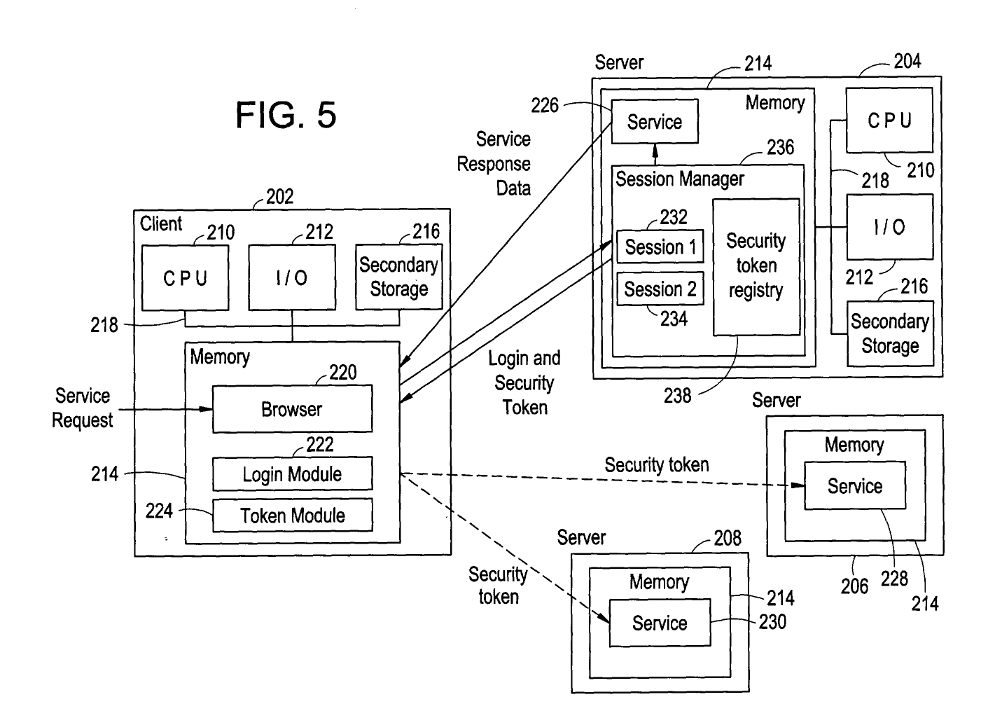

FIG. 5 shows a block diagram of another exemplary system for authentication of a plurality of services 226, 228, and 230 wherein the service 228 returns the service response data directly back to the client 202 in accordance with method and systems consistent with the present invention. As can be seen in the figure, operation is the same as in FIGS. 2, 3a and 3b, but the service 228 returns the service response data back to the client 202 directly instead of back through the session manager 236 and then to the client.

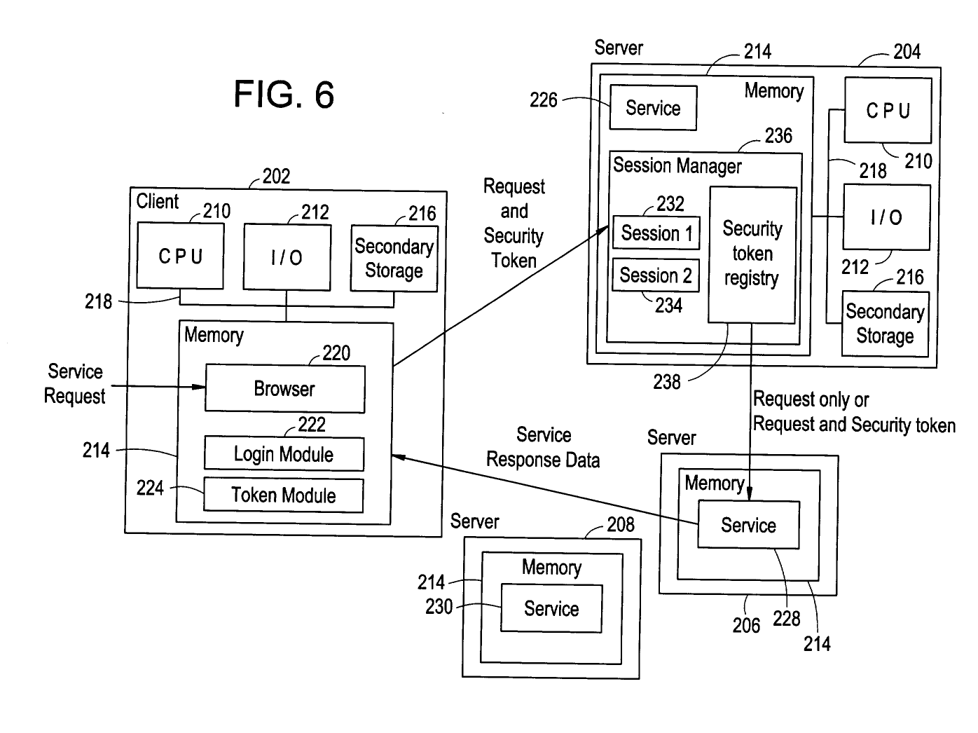

FIG. 6 shows a block diagram of another exemplary system for authentication for a plurality of services 226, 228, and 230 wherein the service 228 resides on a different server 206 than the session manager 236 in accordance with method and systems consistent with the present invention. In this embodiment, operation is similar to the operation illustrated in FIGS. 2, 3a, 3b, and 5. As shown on this figure, the user has already logged in and received a security token from the session manager 236. However, in this embodiment, the requested service 228 resides on a server 206 different from the server 204 that contains the session manager 236.

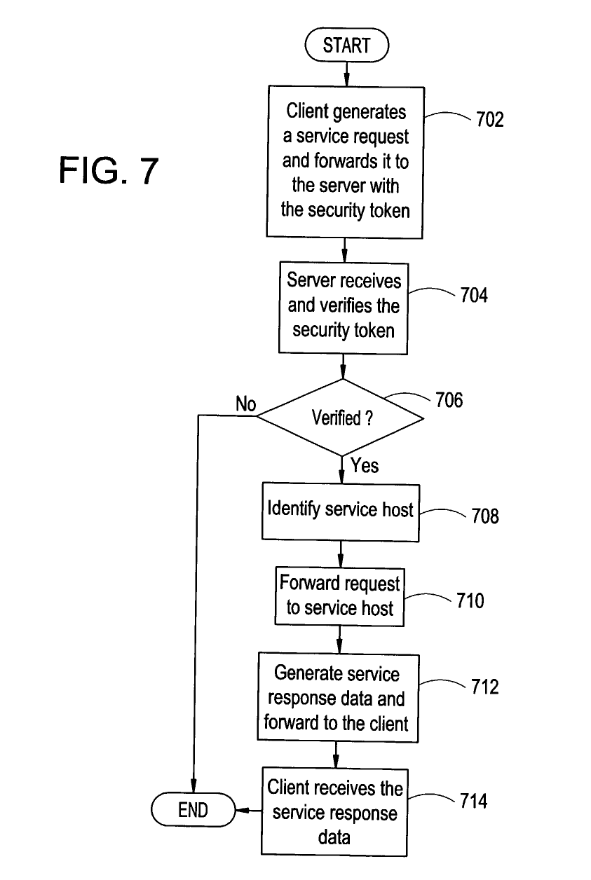

FIG. 7 shows steps of an exemplary method for authentication of a plurality of services 226, 228, and 230 wherein the service 228 resides on a different server 206 than the session manager 236 in accordance with method and systems consistent with the present invention. These steps will be described in conjunction with FIG. 6. According to one scenario, the client 202 generates a service request and forwards it and the security token to the session manager 236 on the server 204 which then evaluates and verifies the submitted security token (step 702). The server 204 receives and verifies the security token (step 704). After successful verification of the security token (step 706), the session manager 236 identifies an appropriate service host 206 (step 708) and forwards the service request to this service host server 206 for processing of the service 228 (step 710). The service 228 then generates the service response data and forwards the service response data to the client 202 (step 712). The direct forwarding of the data from the service 228 to the client 202 may help avoid resource intensive routing of data through the session manager 236. The client 202 receives the service response data for local processing on the client (step 714).

Alternatively, the session manager 236 may accept the request and security token, and forward both the requested token to the service 228, which will both verify the token and perform the requested service. In this way, the session manager 236 acts as an entry server 204 so that the client 202 may have a single entry point to multiple servers even though the session manager is not performing the security token verification.

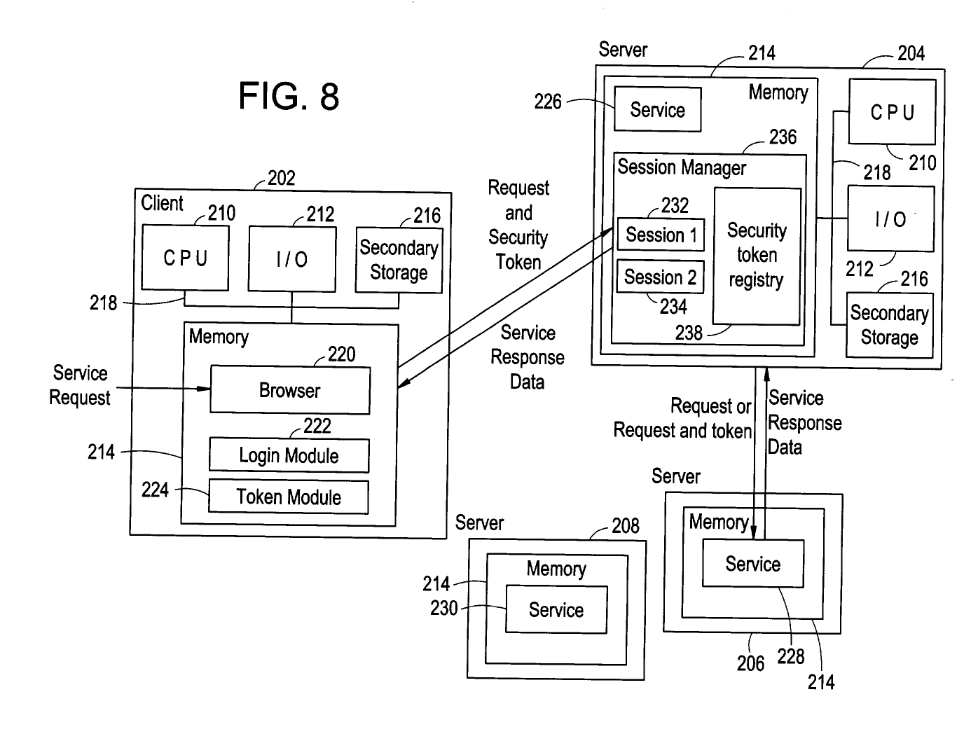

FIG. 8 shows a block diagram of another exemplary system for authentication for a plurality of services 226, 228, and 230 wherein the service 228 resides on a different server 206 than the session manager 236 in accordance with method and systems consistent with the present invention. In this embodiment in accordance with the present invention, operation is similar to the operation illustrated FIG. 6, except that the service response data is routed back to the session manager 236 before being returned to the client 202. As in FIG. 6, verification of the security token may take place on the session manager 236 or the service host server 206.

Sometimes a situation arises in which the request of a service requires a modification of the client 202 utilizing the plurality of services, typically the installation of new software. One example is the use of a Web browser by a user where the request for some specific service such as audio or video requires the installation of a related audio or video plug-in to the browser. More generally, such a situation may occur when a main program necessitates the installation of an auxiliary program to enhance its capability.

Such scenarios may be handled by evaluating whether a new service 226 requires the modification of software installations on the client 202, installing the new software and assigning the previously submitted security token, and possibly optional service connection points, to the newly installed software. One benefit is that the user is freed from additional input of data as the new functionality and related software is automatically extended by the previously assigned security token which may then be used for receiving services related to the newly installed software from the session manager 236.

This also has the benefit that the initial log-in dialogue may be realized via a Web display page issued by a Web server, and therefore fits well into the presentation of Web applications running in a distributed computing environment.

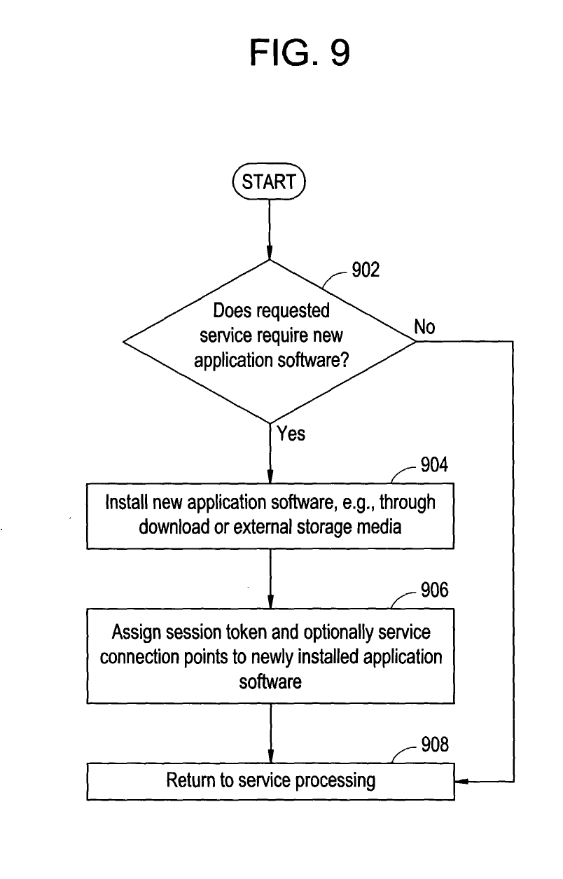

FIG. 9 illustrates a flowchart of the steps for determining whether new application software needs to be installed and associated with an existing security token. First, it is determined whether a new application module is required (step 902). This operation may be performed by the client 202, the server 204 or combination of both.

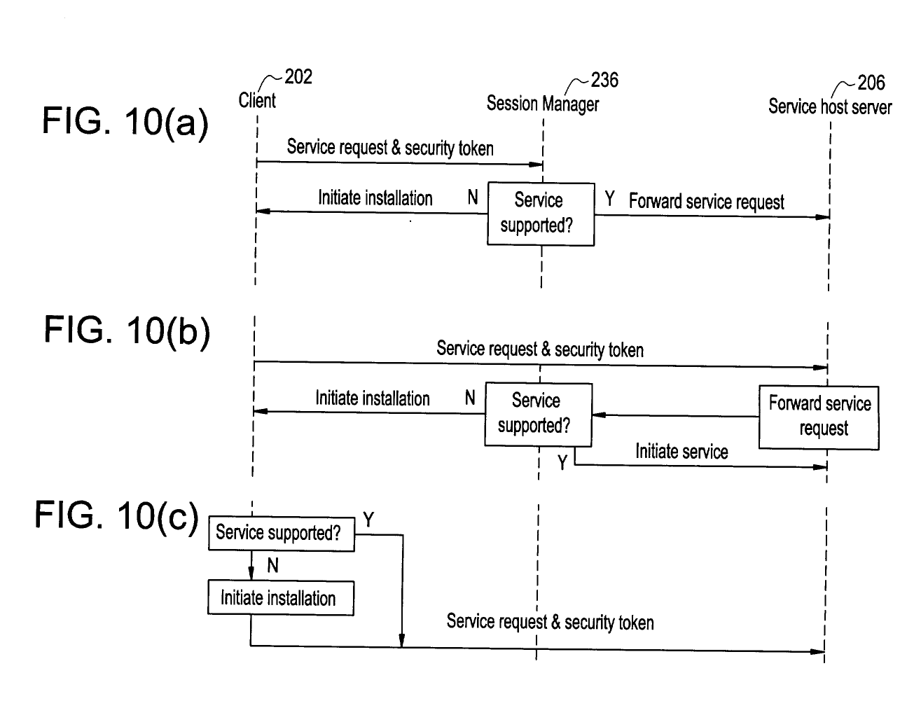

FIG. 10a-10c illustrates different ways of determining whether a new application module should be installed, and the figure will be discussed in conjunction with step 902 of FIG. 9. One possibility illustrated in FIG. 10a shows an example in which information on previously supported services is stored in the session information 232, and then the session manager 236 compares a submitted service request with this list of supported services. In another example shown on FIG. 10b, the service host 204 may, upon processing of a service request, query the session manager 236 to determine whether a service 226 is supported. In yet another example depicted in FIG. 10c, upon initialization of a service request, the client 202 checks whether the requested service 226 is already supported. If not, the related application module or software is installed on the client 202, and then the service request and security token may be submitted to the session manager 236 or service 226.

Referring again to FIG. 9, when it is determined that a new application module is necessary, this new application module may then be installed at the user side (step 904). Again, the application module may be either provided in hardware or in software, and in the software case, the application software may be provided through downloading from the session manager 236, servers, external storage media, etc. Subsequently, an available security token and optional service connection points, are assigned to the newly installed application module (step 906). As a result, upon activation of the newly installed application module, the application module may generate a service request with the assigned security token and optional service connection points. Therefore, operations for the activation of a requested service 226 at the client 202 may be achieved without interrupting the flow of service processing, particularly without requesting a repeated authentication for the newly installed application module. After assignment of the security token to the new application module, the system returns to service processing (step 908).

Other embodiments of the invention will be apparent to those skilled in the art from consideration of the specification and practice of the invention disclosed herein. Furthermore embodiments of the present invention may be implemented by computer programs that may be stored on computer-readable media. It is intended that the specification and examples be considered as exemplary, with a true scope and spirit of the invention being indicated by the following claims.

What is claimed is:

1. A method in a data processing system for providing authentication for a plurality of services, comprising the steps of:
receiving authentication information from a client to access one of the plurality of services;
determining validity of the authentication information; and
when it is determined that the authentication information is valid,
sending to the client a security token that enables the client to access all of the plurality of services.

2. The method of claim 1, wherein the method further comprises:
receiving the security token;
verifying the authenticity of the security token; and
providing access to one or more of the plurality of services based on the verification of the security token.

3. The method of claim 2, wherein the method further comprises:
receiving a service request;
identifying a location of the requested service; and
forwarding the service request to the identified service.

4. The method of claim 3, wherein the method further comprises:
receiving service data in response to processing of the service request by the identified service.

5. The method of claim 1, wherein the method further comprises:
receiving a service request; and
sending at least one service connection point associated with the requested service to provide contact to the requested service.

6. The method of claim 1, wherein the method further comprises:
maintaining session context information comprising the security token, the authentication information, a list of the plurality of services, and a list of service connection points to plurality of services.

7. The method of claim 1, wherein the method further comprises:
releasing the security token at the end of a service session.

8. The method of claim 7, wherein the method further comprises:
finalizing active services; and
saving related service data before releasing the security token.

9. The method of claim 1, wherein the method further comprises:
modifying the security token during a session.

10. A method in a data processing system for providing authentication for a plurality of services, comprising the steps of:
sending authentication information to access one of the services in the plurality of services; and
receiving a security token enabling access to the plurality of services.

11. The method of claim 10, wherein the method further comprises the steps of:
sending the received security token to access a different one of the plurality of services without sending the authentication information.

12. The method of claim 11, wherein the method further comprises the steps of:
sending a request for a service with the security token.

13. The method of claim 12, wherein the method further comprises the steps of:
receiving service data in response to the request for the service.

14. The method of claim 10, wherein the method further comprises the steps of:
receiving one or more service connection points associated with one or more of the plurality of services to provide contact to the one or more services.

15. The method of claim 10, wherein the method further comprises the steps of:
requesting termination of a session to release the received security token.

16. A method in a data processing system for providing authentication for a plurality of services, comprising the steps of:
sending authentication information by a client to access one of the plurality of services;
receiving the authentication information from the client to access one of the plurality of services;
determining validity of the authentication information;
when it is determined that the authentication information is valid,
sending to the client a security token that enables the client to access all of the plurality of services;
receiving, by the client, the security token enabling access to the plurality of services;
sending the received security token to one of the plurality of services to access the service without sending the authentication information;
receiving the security token by the service;
verifying the authenticity of the security token; and
providing access to the service based on the verification of the security token.

17. A data processing system for providing authentication for a plurality of services, comprising:
a memory having program instructions; and
a processor configured to execute the program instructions to receive authentication information from a client to access one of the plurality of services, determine validity of the authentication information, and when it is determined that the authentication information is valid, send to the client a security token that enables the client to access all of the plurality of services.

18. A data processing system for providing authentication for a plurality of services, comprising:
a memory having program instructions; and
a processor configured to execute the program instructions to send authentication information to access one of the services in the plurality of services, and receive a security token enabling access to the plurality of services.

19. A computer-readable medium containing instructions for controlling a data processing system to perform a method for system for providing authentication for a plurality of services comprising the steps of:
receiving authentication information from a client to access one of the plurality of services;
determining validity of the authentication information; and
when it is determined that the authentication information is valid,
sending to the client a security token that enables the client to access all of the plurality of services.

20. The computer-readable medium of claim 19, wherein the method further comprises the steps of:
receiving the security token;
verifying the authenticity of the security token; and
providing access to one or more of the plurality of services based on the verification of the security token.

21. The computer-readable medium of claim 20, wherein the method further comprises the steps of:
receiving a service request;
identifying a location of the requested service; and
forwarding the service request to the identified service.

22. The computer-readable medium of claim 21, wherein the method further comprises the steps of:
receiving service data in response to processing of the service request by the identified service.

23. The computer-readable medium of claim 19, wherein the method further comprises the steps of:
receiving a service request; and
sending at least one service connection point associated with the requested service to provide contact to the requested service.

24. The computer-readable medium of claim 19, wherein the method further comprises the steps of:
maintaining session context information comprising the security token, the authentication information, a list of the plurality of services, and a list of service connection points to plurality of services.

25. The computer-readable medium of claim 19, wherein the method further comprises the steps of:
releasing the security token at the end of a service session.

26. The computer-readable medium of claim 19, wherein the method further comprises the steps of:
finalizing active services; and
saving related service data before releasing the security token.

27. The computer-readable medium of claim 19, wherein the method further comprises the steps of:
modifying the security token during a session.

28. A computer-readable medium containing instructions for controlling a data processing system to perform a method for system for providing authentication for a plurality of services comprising the steps of:
sending authentication information to access one of the services in the plurality of services; and
receiving a security token enabling access to the plurality of services.

29. The computer-readable medium of claim 28, wherein the method further comprises the steps of:
sending the received security token to access a different one of the plurality of services without sending the authentication information.

30. The computer-readable medium of claim 29, wherein the method further comprises the steps of:
sending a request for a service with the security token.

31. The computer-readable medium of claim 30, wherein the method further comprises the steps of:
receiving service data in response to the request for the service.

32. The computer-readable medium of claim 28, wherein the method further comprises the steps of:
receiving one or more service connection points associated with one or more of the plurality of services to provide contact to the one or more services.

33. The computer-readable medium of claim 28, wherein the method further comprises the steps of:
requesting termination of a session to release the received security token.

34. A data processing system for providing authentication for a plurality of services, comprising:
means for receiving authentication information from a client to access one of the plurality of services;
means for determining validity of the authentication information; and
means for, when it is determined that the authentication information is valid, sending to the client a security token that enables the client to access all of the plurality of services.
